(19) United States
(12) Patent Application Publication
(10) Pub. No.: US 2017/0110798 A1
(43) Pub. Date: Apr. 20, 2017

(54) APPARATUS AND METHODS FOR GROUND PLANE LOADING OF ANTENNAE

(71) Applicant: Pulse Finland OY, Kempele (FI)

(72) Inventors: Prasadh Ramachandran, Oulu (FI); Petteri Annamaa, Oulunsalo (FI)

(21) Appl. No.: 14/885,494

(22) Filed: Oct. 16, 2015

(51) Int. Cl. H01Q 9/04; H01Q 1/24

(52) U.S. Cl. CPC H01Q 9/04; H01Q 1/243

(57) ABSTRACT

High radiation-efficiency antenna apparatus, and methods of manufacturing and utilizing the same. In one embodiment, an intentionally “loaded” antenna configuration is used within a handheld mobile device (e.g., cellular telephone) in order to enhance radiation efficiency for a given size antenna, or conversely allow for a reduction in size of the antenna for the same electrical performance. In one implementation, the antenna (and optionally chassis of the mobile device) is loaded through use of a magnetically permeable structure to increase propagation of surface currents, thereby increasing the electrical length of the antenna (and enhancing radiation efficiency) without any significant modification to the form factor of the antenna/chassis.

### COPYRIGHT

A portion of the disclosure of this patent document contains material that is subject to copyright protection. The copyright owner has no objection to the facsimile reproduction by anyone of the patent document or the patent disclosure, as it appears in the Patent and Trademark Office patent files or records, but otherwise reserves all copyright rights whatsoever.

### TECHNOLOGICAL FIELD

The present disclosure relates generally to antenna apparatus for use in electronic devices such as wireless or portable radio devices, and more particularly in one exemplary aspect to antennae with enhanced ground plane loading, and methods of manufacturing, tuning, and utilizing the same.

### DESCRIPTION OF RELATED TECHNOLOGY

Internal antennas are commonly found in most modern radio devices, such as mobile computers, tablets, mobile phones, Blackberry® devices, smartphones, personal digital assistants (PDAs), or other personal communication devices (PCD). Typically, these antennas comprise a planar radiating plane and a ground plane parallel thereto, which are connected to each other by a short-circuit conductor in order to achieve the matching of the antenna. The structure is configured so that it functions as a resonator at the desired operating frequency. It is also a common requirement that the antenna operate in more than one frequency band (such as dual-band, tri-band, or quad-band mobile phones), in which case two or more resonators are used. Typically, these internal antennas are located on a printed circuit board (PCB) of the radio device, inside a plastic enclosure that permits propagation of radio frequency waves to and from the antenna(s), and/or in other locations on the device (such as around the periphery of the housing).

Recent advances in the development of affordable and power-efficient display technologies for mobile applications (such as liquid crystal displays (LCD), light-emitting diodes (LED) displays, organic light emitting diodes (OLED), thin film transistors (TFT), etc.) have resulted in a proliferation of mobile devices featuring large displays with large screen areas.

Despite the requirement of such large screens, there is also a strong incentive to utilize the smallest possible device form factor (i.e., length, width, thickness) that will accommodate such display devices and the other components required by the implementation. This results in many portable devices which have little extra length or width over and above that of the requirements for the display device, and hence a very thin perimeter around the display device in order to accommodate these antenna structures. In that the antennae used in such devices are spatially limited to such small dimensions (i.e., overall length/width/height of the device), their effective electrical length (and hence ultimate performance capability, including radiation efficiency) is similarly limited under such prior art approaches. Even in devices with less aggressive display form factors, the overall size and shape of the device is typically limited, so as to make it as small as possible while still performing all of the desired functions, including support of multiple air interfaces and multiple frequency bands associated therewith.

Accordingly, there is a need for improved antenna apparatus and methods which allow an antenna to increase its effective electrical length (and hence performance) in such limited form factor applications without requiring any significant increase in the length, width or height of the host mobile device; i.e., the antenna needs to remain the same physical size, yet perform electrically as if it were larger or conversely, maintain the same performance in yet a smaller form factor.

### SUMMARY

The present disclosure satisfies the foregoing needs by providing, inter alia, a “loaded” antenna apparatus and methods of tuning, manufacturing and use.

In a first aspect of the disclosure, an antenna apparatus for use in a portable communications device is disclosed. In one embodiment, the antenna apparatus includes a radiator element; a ground plane; and a load structure; and wherein at least a portion of the load structure comprises a composite material, the at least portion enhancing the radiation efficiency of the antenna apparatus.

In one variant, the load structure is incorporated into one or more of a portable communications device chassis, a portable communications device antenna frame and a portable communications device loading ring.

In another variant, the composite material has a magnetic permeability equal to approximately 2.5 and a dielectric permeability equal to approximately 8.1.

In yet another variant, the composite material has a dielectric permittivity to magnetic permeability ratio of approximately 3.2.

In yet another variant, the load structure is incorporated into two or more of a portable communications device chassis, a portable communications device antenna frame and a portable communications device loading ring.

In yet another variant, the composite material is insert-molded into at least a portion of the load structure.

In yet another variant, the load structure comprises a ring like structure configured to be disposed about a periphery of the portable communications device.

In yet another variant, the ring like structure is configured to be disposed on the smallest one of a length dimension, a width dimension and a height dimension for the portable communications device.

In yet another variant, the ring like structure is a substantially planar structure having a thickness on the order of approximately 1 mm.

In yet another variant, the composite material is configured to provide structural support and/or stability for the portable communications device.

In a second aspect of the disclosure, a mobile communications device is disclosed. In one embodiment, the mobile communications device includes a “loaded” antenna apparatus with load structure and ground plane.

In a second embodiment, the mobile communications device includes a housing having at least a top and a bottom surface as well as two side surfaces that are disposed adjacent to both the top and the bottom surfaces; a chassis disposed within the housing; and an antenna apparatus disposed on an antenna frame. The antenna apparatus includes a radiator element; a ground plane;

and a composite material disposed proximate at least the ground plane, the composite material configured to enhance the radiation efficiency of the antenna apparatus.

In one variant, the mobile communications device further includes a ring like structure that is disposed on at least the top and the two side surfaces of the housing.

In another variant, the ring like structure includes the composite material.

In yet another variant, the chassis includes the composite material.

In yet another variant, the antenna frame includes the composite material; and the incorporation of the composite material into the ring like structure, the chassis and the antenna frame is configured to improve the radiation efficiency of the antenna apparatus as compared with a portable communications device in which the composite material is only disposed on a single one of the ring like structure, the chassis and the antenna frame.

In yet another variant, the composite material has a magnetic permeability equal to approximately 2.5 and a dielectric permeability equal to approximately 8.1.

In yet another variant, the composite material has a dielectric permittivity to magnetic permeability ratio of approximately 3.2.

In yet another variant, the composite material is insert-molded into at least a portion of the chassis.

In a third aspect of the disclosure, a loading structure for use with one or more antenna radiating elements is disclosed. In one embodiment, the structure comprises a ring shape which is configured to substantially encompass a display device mounted within an aperture in the ring.

In a fourth aspect of the disclosure, a method of operating an antenna apparatus is disclosed.

In a fifth aspect of the disclosure, a method of tuning an antenna apparatus is disclosed.

In a sixth aspect of the disclosure, a method of manufacturing an antenna apparatus is disclosed.

In a seventh aspect of the disclosure, a method of operating a mobile device is disclosed.

In an eighth aspect of the disclosure, a method of enhancing the radiation efficiency of an antenna apparatus is disclosed. In one embodiment the method includes providing a radiator element; providing a ground plane; disposing a composite material onto a loading structure comprised of a metallic material; and disposing the load structure proximate the radiator element and the ground plane. At least a portion of the loading structure is configured to enhance the radiation efficiency of the antenna apparatus.

In one variant, the composite material has a dielectric permittivity to magnetic permeability ratio of approximately 3.2.

Further features of the present disclosure, its nature and various advantages will be more apparent from the accompanying drawings and the following detailed description.

### BRIEF DESCRIPTION OF THE DRAWINGS

The features, objectives, and advantages of the disclosure will become more apparent from the detailed description set forth below when taken in conjunction with the drawings, wherein:

FIG. 1 is a rear perspective view detailing the configuration of a first embodiment of a mobile device with “loaded” antenna apparatus according to the present disclosure.

FIG. 2 is a front elevation view detailing the configuration of the mobile device with “loaded” antenna assembly (some components removed for clarity) of FIG. 1.

FIG. 3 is a side elevation view detailing the configuration of the mobile device with “loaded” antenna apparatus of FIG. 1.

FIG. 4 is a graph showing antenna (radiation) efficiency as a function of frequency for a variety of different prior art and inventive embodiments, illustrating various aspects of the improvements of the inventive embodiments over the prior art.

FIG. 5 is a logical flow diagram illustrating one embodiment of a method of manufacturing the antenna apparatus of the present disclosure.

All Figures disclosed herein are © Copyright 2015 Pulse Finland Oy. All rights reserved.

### DETAILED DESCRIPTION OF THE PREFERRED EMBODIMENT

Reference is now made to the drawings wherein like numerals refer to like parts throughout.

As used herein, the terms “antenna,” “antenna system,” “antenna assembly”, and “multi-band antenna” refer without limitation to any system that incorporates a single element, multiple elements, or one or more arrays of elements that receive/transmit and/or propagate one or more frequency bands of electromagnetic radiation. The radiation may be of numerous types, e.g., microwave, millimeter wave, radio frequency, digital modulated, analog, analog/digital encoded, digitally encoded millimeter wave energy, or the like. The energy may be transmitted from location to another location, using, or more repeater links, and one or more locations may be mobile, stationary, or fixed to a location on earth such as a base station.

As used herein, the terms “board” and “substrate” refer generally and without limitation to any substantially planar, stepped, or curved surface or component upon which other components can be disposed. For example, a substrate may comprise a single or multi-layered printed circuit board (e.g., FR4), a semi-conductive die or wafer, or even a surface of a housing or other device component, and may be substantially rigid or alternatively at least somewhat flexible.

The terms “frequency range”, “frequency band”, and “frequency domain” refer without limitation to any frequency range for communicating signals. Such signals may be communicated pursuant to one or more standards or wireless air interfaces.

As used herein, the terms “loaded”, “loading” and similar refer without limitation to alterations in the composition or constituency of all or part of an antenna component and/or chassis element used as part of a radiating structure. Loading of an antenna element or chassis may include for instance substituting a particular material or combination of materials for an extant structure or material, coating (such as coating of an extant component, or a particular material), doping, etc.

As used herein, the terms “portable device”, “mobile computing device”, “client device”, “portable computing device”, and “end user device” include, but are not limited to, personal computers (PCs) and minicomputers, whether desktop, laptop, or otherwise, set-top boxes, personal digital assistants (PDAs), handheld computers, personal communicators, tablet computers, portable navigation aids, J2ME equipped devices, cellular telephones, smartphones, personal integrated communication or entertainment devices, or literally any other device capable of interchanging data with a network or another device.

Furthermore, as used herein, the terms “radiator,” “radiating plane,” and “radiating element” refer without limitation to an element that can function as part of a system that receives and/or transmits radio-frequency electromagnetic radiation; e.g., an antenna.

The terms “RF feed,” “feed,” “feed conductor,” and “feed network” refer without limitation to any energy conductor and coupling element(s) that can transfer energy, transform impedance, enhance performance characteristics, and conform impedance properties between an incoming/outgoing RF energy signals to that of one or more connective elements, such as for example a radiator.

As used herein, the terms “top”, “bottom”, “side”, “up”, “down”, “left”, “right”, and the like merely connote a relative position or geometry of one component to another, and in no way connote an absolute frame of reference or any required orientation. For example, a “top” portion of a component may actually reside below a “bottom” portion when the component is mounted to another device (e.g., to the underside of a PCB).

As used herein, the term “wireless” means any wireless signal, data, communication, or other interface including without limitation Wi-Fi, Bluetooth, 3G (e.g., 3GPP, 3GPP2, and UMTS), HSDPA/HSUPA, TDMA, CDMA (e.g., IS-95A, WCDMA, etc.), FHSS, DSSS, GSM, PAN/802.15, WiMAX (802.16), 802.20, narrowband/FDMA, OFDM, PCS/DCS, Long Term Evolution (LTE) or LTE-Advanced (LTE-A), analog cellular, CDPD, satellite systems such as GPS, millimeter wave or microwave systems, optical, acoustic, and infrared (i.e., IrDA).

### Overview

The present disclosure provides, in one salient aspect, an antenna apparatus for use in a mobile radio device which advantageously provides reduced size and cost, or alternatively improved antenna performance for the same size of antenna (and chassis). In one embodiment, the mobile radio device includes a “loaded” structure or element disposed proximate a ground structure of the mobile device antenna which increases the effective electrical dimension of the antenna and/or chassis, while maintaining the extant mobile device dimensions. This is accomplished through use of one or more appropriate loading materials as part of the construction of the mobile device, which modifies the electrical performance of the antenna/chassis (i.e., radiation efficiency in one or more frequency bands of interest) through, inter alia, creation of enhanced surface currents.

Conversely, the apparatus and methods of the present disclosure allow use of a smaller antenna form factor than would otherwise be required for a comparable level of performance, and hence the chassis (and device as a whole) can be reduced in size.

Advantageously, the various aspects of the present disclosure can be applied to any wireless device, and to any number of different frequency bands associated with various air interfaces including, for example, some or all bands within the GSM, WCDMA, and LTE Standards, as well as others.

Moreover, certain embodiments of the loaded antenna/chassis disclosed herein can provide structural support and stability to the host mobile device (and hence add mechanical strength and options for mounting other components), while also improving its electrical performance.

### DETAILED DESCRIPTION OF EXEMPLARY EMBODIMENTS

Detailed descriptions of the various embodiments and variants of the apparatus and methods of the disclosure are now provided. While primarily discussed in the context of mobile devices, the various apparatus and methodologies discussed herein are not so limited. In fact, many of the apparatus and methodologies described herein are useful in any number of simple or complex antennas, whether associated with mobile or fixed devices that can benefit from the loaded antenna/chassis methodologies and apparatus described herein.

### Exemplary Antenna Apparatus and Mobile Device

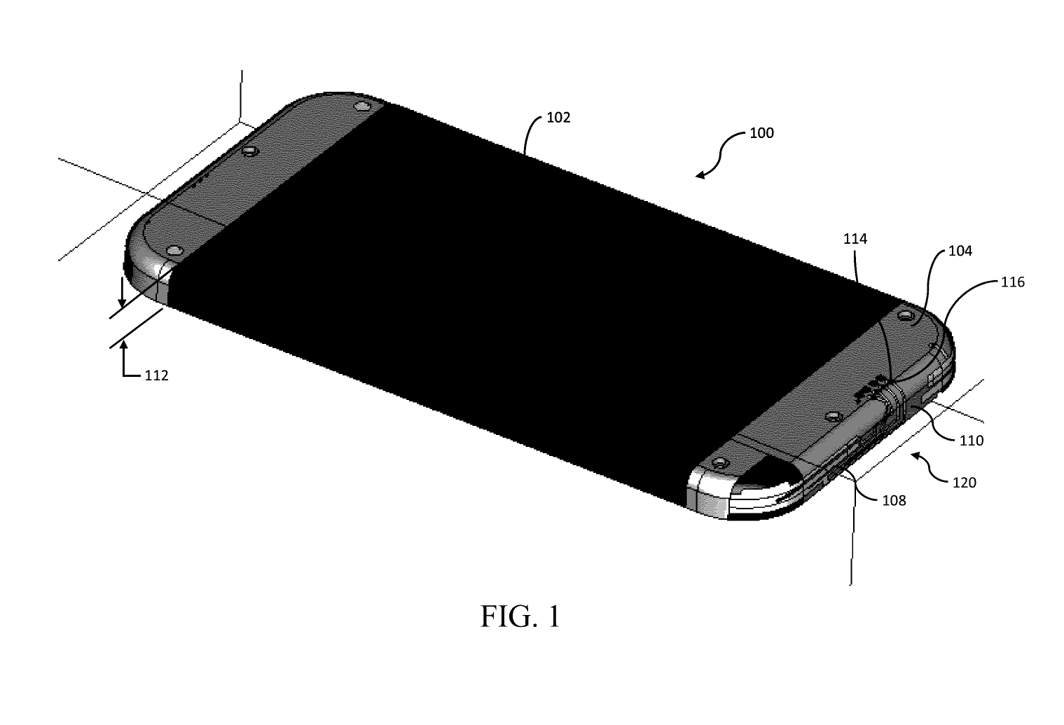

Referring now to FIGS. 1-3, exemplary embodiments of the radio antenna apparatus of the disclosure, and mobile radio apparatus, are described in detail.

It will be appreciated that while these exemplary embodiments of the antenna apparatus of the disclosure are implemented using a loop antenna (selected in these embodiments for their desirable attributes and performance), the disclosure is in no way limited to such configurations, and in fact can be implemented using other technologies, such as monopole, planar inverted-L antenna (PILA), inverted-L antenna (ILA), planar inverted-F antenna (PIFA), semi-PIFA, patch, dipole, microstrip antennas and can also be used for linear/circular polarized antennas. For example, in one exemplary embodiment, the principles of the present disclosure could be utilized in conjunction with the multi-tap frequency switchable antenna apparatus described in co-owned and co-pending U.S. patent application Ser. No. 14/877,393 filed Oct. 7, 2015 and entitled “Multi-Tap Frequency Switchable Antenna Apparatus, Systems and Methods”, the contents of which are incorporated herein by reference in its entirety.

One exemplary embodiment of an antenna apparatus for use in a mobile radio device 100 is presented in FIGS. 1-3. As shown in FIG. 1, the exemplary mobile device 100 includes an exterior housing 102 (also referred to as enclosure) along with a chassis (not shown) and antenna frame 104. The chassis generally runs along the whole dimension (length, width, height) of the mobile radio device and can be fabricated from any number of suitable materials. In one exemplary embodiment, the chassis is manufactured from a metallic material such as magnesium or aluminum. The antenna frame 104, which is distinguishable from the mid-frame (not shown) is generally disposed between the display 106 and back portion of the housing, and is also referred to herein as the antenna carrier. In one variant, the chassis and antenna frame are at least partly composed of a composite material with properties such as, for example, a magnetic permeability (“μᵣ”) equal to approximately 2.5 and a dielectric permeability (“Eᵣ”) equal to approximately 8.1.

In one embodiment, the composite material is insert-molded onto the chassis and antenna frame so that the composite material essentially envelops or covers the underlying chassis and antenna frame. In an alternative variant, the composite material is deposited onto the chassis and antenna frame using a three-dimensional (“3D”) printing process using, for example, the techniques described in co-owned and co-pending U.S. patent application Ser. No. 14/620,108 filed Feb. 11, 2015 and entitled “Methods and Apparatus for Conductive Element Deposition and Formation”; and/or co-owned and co-pending U.S. patent application Ser. No. 14/736,040 filed Jun. 10, 2015 and entitled “Methods and Apparatus for Conductive Element Deposition and Formation”, the contents of each of the foregoing being incorporated herein by reference in their entireties. In yet another alternative variant, the composite material is formed as a discrete part and fixed tightly with the chassis and antenna frame. A variety of other manufacturing methods may be used consistent with the disclosure.

The antenna assembly 120 of the embodiment of FIGS. 1-3 further comprises one or more radiator elements 108 configured to be fitted against a side surface 110 of the enclosure 102. The side surface 110 can be any of the top, bottom, left, right, front, or back surfaces of the mobile radio device, although the bottom surface of the mobile device is illustrated in FIG. 1. Typically, modern portable devices are manufactured such that their thickness 112 is much smaller than the length or the width of the device housing. As a result, the radiator element of the illustrated embodiment and other radiator elements disposed on these side surfaces (e.g., left, right, top, bottom) are fabricated to have an elongated shape such that the length is greater than the width.

To access the device feed port, an opening 114 is fabricated in the device enclosure. In the embodiment shown in FIG. 1, the opening 114 extends through the side surface 110 and serves to pass through a feed conductor 116 from a feed engine that is a part of the device RF section (not shown), located on the inside of the device. Alternatively, the opening is fabricated proximate to the radiator feed point; various other configurations will be recognized by those of ordinary skill given the present disclosure.

In the illustrated embodiment, the antenna assembly 120 of FIGS. 1-3 further comprises a dielectric antenna cover (not shown) that is installed directly above the radiator element 108. The cover, in the illustrated embodiment, is fabricated from any suitable dielectric material (e.g., plastic or glass). The cover is attached by a variety of suitable means: adhesive, press-fit, snap-in with support of additional retaining members, etc. Alternatively, the antenna cover can be manufactured from a metallic part in instances in which the feed element is coupled to the outer metallic portion so as to make the antenna cover part of the antenna. The radiating element 108 further comprises a ground point (not shown) that is configured to couple the radiating element 108 to the device ground plane 118 (e.g., housing/chassis); see FIG. 3.

In one exemplary implementation, the radiator element is approximately 10 mm (0.3 in) in width and 50 mm (2 in) in length. It will be appreciated by those skilled in the art that the above antenna radiator sizes are exemplary and are adjusted based on the actual size of the device and its operating band. In one variant, the electrical size of the antenna is adjusted by the use of a lumped reactive component (not shown), in addition to the “loading” element(s) (e.g., chassis, antenna frame, and/or loading ring) described herein.

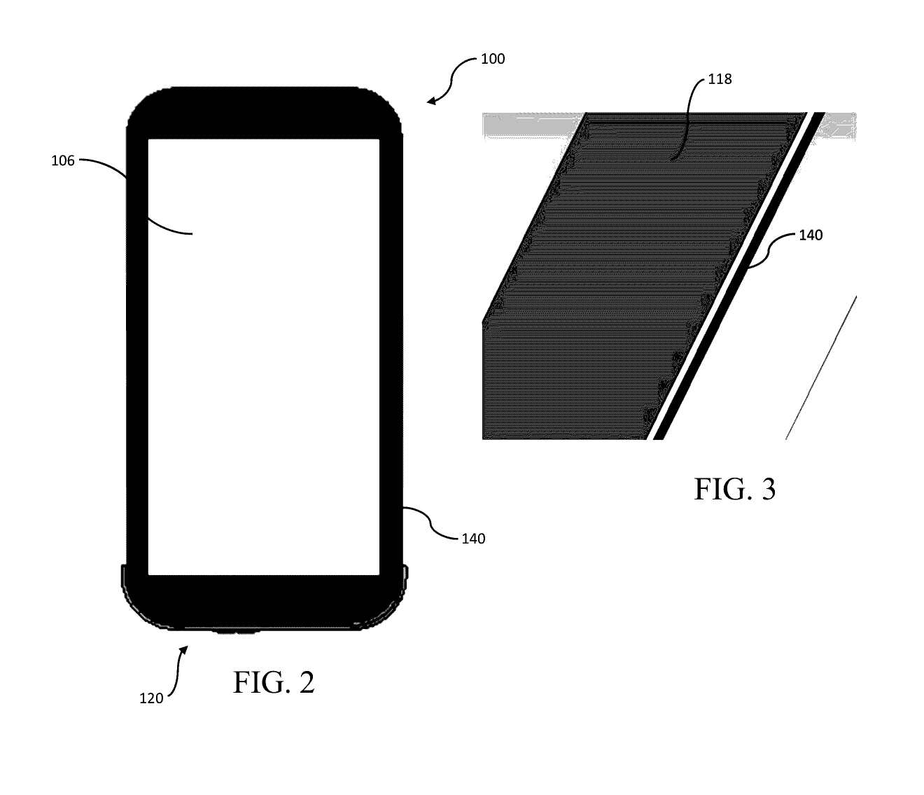

As shown in FIG. 2 (front view of device 100 of FIG. 1), the exemplary device also includes a loading structure 140. In the illustrated implementation, the structure 140 is a “ring”; i.e., it is a planar (or substantially planar) structure which effectively surrounds the perimeter of the display device, although it will be appreciated that other shapes, dimensions, and constructions (e.g., multiple pieces) may be used consistent with the disclosure. In one exemplary implementation, one or more of the composite antenna frame/composite chassis are obviated in favor of the aforementioned loading ring. While it has been found by the Assignee hereof that the best antenna loading for the purposes of, inter alia, improving upon antenna radiation efficiency is achieved via the incorporation of the composite material onto the antenna frame and/or mobile device chassis, such a usage scenario contributes to the overall height of the device.

In instances where such added height is undesirable, the use of the loading ring 140 by itself provides a good compromise between size and performance as the loading ring merely expands the length/width dimensions of the mobile device by, in one embodiment, approximately 1 mm (0.039 in). Similar to its incorporation onto the chassis and/or antenna frame, the incorporation of the composite material onto/into a loading ring can be accomplished using any number of suitable manufacturing techniques including insert-molding, 3D printing and/or forming a discrete loading ring 140 manufactured entirely from the composite material. Again, the composite material is chosen in this implementation for its material properties and in an exemplary implementation has a magnetic permeability (“μᵣ”) equal to approximately 2.5 and a dielectric permeability (“Eᵣ”) equal to approximately 8.1. For an antenna with a higher Eᵣ and with a higher μᵣ, the electrical length for the antenna increases. However, with a higher μᵣ, the loss tangent increases, thus dropping the antenna efficiency. With the use of the exemplary composite material, there is an appropriate balance of Eᵣ/μᵣ. (=˜3.2) and loss tangent such that this material can be used for antenna miniaturization.

FIG. 3 illustrates a side view of the mobile device 100 of FIGS. 1-2, showing ground plane 118 along with the loading structure/ring 140 disposed adjacent the ground plane 118 (5 mm (0.2 in) in the illustrated implementation), although other values can be used, and even variable thicknesses can be employed to, for example, customize or tailor the interaction between the load ring 140 and ground plane 118 in various regions of the device. In an exemplary implementation, and as discussed previously herein, the thickness of the loading structure 140 is on the order of 1 mm (0.039 in); however, the amount of loading applied to the radiator will increase as the thickness of the composite material in increased. In this fashion, the loading ring 140 advantageously has a large surface area to enhance effective antenna electrical “size” (installed on an exemplary 132 mm (5.2 in)×66 mm (2.6 in) overall platform in the illustrated implementation), but yet very thin thickness (so as to not appreciably increase the overall thickness of the host mobile device 102).

In operation, the loading ring 140 presence affects the operation of the antenna radiator elements by affecting the surface currents for the mobile device 100. In typical prior art mobile phone types of devices, the feeding radiator operates as one part of the antenna; however, the other part of the antenna includes the metallic chassis. In typical operation, there will be surface currents on the chassis and depending upon the frequency of operation, the antenna operation will be affected by the length of the device. Accordingly, when the length of the device is reduced (e.g., from 130 mm (5.1 in) to 100 mm (3.9 in)), then the performance at lower frequencies (e.g., 700-790 MHz) will drop. Moreover, if the device is made even shorter (e.g., down to 50 mm (1.97 in)), then the performance at slightly higher frequencies (e.g., 850 MHz) will also drop. The incorporation of the loading ring 140 in effect mimics a larger antenna structure by, inter alia, extending the area/lengths that currents must travel, and hence makes the antenna structure electrically operate as if it were physically larger (i.e., a larger antenna without the loading ring). The use of the composite material in order to increase the effective length of the ground plane can also be utilized in conjunction with other known methods, such as, increasing the overall length of the mobile device, adding an extension arm that is tapped at an edge of the device, and/or making a slot on the ground plane thus forcing the currents to take a longer path. These aforementioned methods contribute to the improved radiation efficiency at the corresponding resonant frequencies which have been limited by the chassis mode and hence the chassis length.

Moreover, the antenna configuration described above with respect to FIGS. 1-3 allows construction of an antenna that results in a very small space used within the device size, in that to otherwise gain the same level of electrical performance (without the loading structure 140) in terms of radiation efficiency, a larger radiating element would be required. Such small volume antennas advantageously facilitate antenna placement in various locations on the device chassis, and expand the number of possible locations and orientations within the device, and most importantly do not necessitate a larger overall device form factor.

As noted above, certain embodiments of the loaded antenna/chassis disclosed herein can provide structural support and stability to the host mobile device (and hence add mechanical strength and options for mounting other components), while also improving its electrical performance. For example, the load ring 140 shown in FIGS. 2 and 3 can be used to stiffen or add rigidity to the mobile device housing and frame as a whole (especially when fabricated as a single planar composite layer), and also can be used as a direct or indirect base or platform for mounting other components such as display elements, power supplies, etc. Such added rigidity can improve upon user experience by limiting instances where, for example, the displays of the mobile devices can become cracked or otherwise damaged.

Antenna performance is improved in the illustrated embodiments (compared to the existing solutions) largely because the ground plane 118 (and to a lesser effect the radiator element(s) 108) is/are loaded by the loading ring 140, the latter making the antenna/chassis combination seem electrically larger for the same size of radiating element 108, and hence enhancing radiation efficiency (i.e., radiated power effectively derived from the antenna as compared to input power to the antenna).

The resonant frequency of the antenna is controlled by (i) altering the size of the loop (either by increasing/decreasing the length of the radiator, or by adding series capacitor/inductor); and/or (ii) the coupling distance between the antenna and the metallic chassis. Moreover, the loading ring 140 preferably should be placed on the edges of the device in order to maximize the surface currents and minimize mobile device thickness. However, it is appreciated that the composite loading structure material can also be placed in other locations (for example, the back portion of the enclosure).

In one embodiment, mobile device 102 is a multi-band device with multiple radiating elements 108. The lower frequency band (i.e., that associated with one of the two radiating elements 108 operating at lower frequency) comprises a sub-GHz Global System for Mobile Communications (GSM) band (e.g., GSM710, GSM750, GSM850, GSM810, GSM900), while the higher band comprises a GSM1900, GSM1800, or PCS-1900 frequency band (e.g., 1.8 or 1.9 GHz).

In another embodiment, the low or high band comprises the Global Positioning System (GPS) frequency band, and the antenna is used for receiving GPS position signals for decoding by e.g., an internal GPS receiver. In one variant, a single upper band antenna assembly operates in both the GPS and the Bluetooth frequency bands.

In another variant, the high-band comprises a Wi-Fi (IEEE Std. 802.11) or Bluetooth frequency band (e.g., approximately 2.4 GHz), and the lower band comprises GSM710, GSM750, GSM850, GSM810, GSM900 frequency band.

In another embodiment, two or more antennas, configured in accordance with the principles of the present disclosure, operate in the same frequency band thus providing, inter alia, diversity for Multiple In Multiple Out (MIMO) or for Multiple In Single Out (MISO) applications.

Other embodiments of the disclosure configure the antenna apparatus to cover LTE/LTE-A (e.g., 698 MHz-740 MHz, 900 MHz, 1800 MHz, and 2.5 GHz-2.6 GHz), WWAN (e.g., 824 MHz-960 MHz, and 1710 MHz-2170 MHz), and/or WiMAX (2.3, and 2.5 GHz) frequency bands.

As persons skilled in the art will appreciate, the frequency band composition given above may be modified as required by the particular application(s) desired. Moreover, the present disclosure contemplates yet additional antenna structures within a common device (e.g., tri-band or quad-band) with one, two, three, four, or more separate antenna assemblies where sufficient space and separation exists. Each individual antenna assembly can be further configured to operate in one or more frequency bands. Therefore, the number of antenna assemblies does not necessarily need to match the number of frequency bands.

The disclosure further contemplates using additional antenna elements for diversity/MIMO type of application. The location of the secondary antenna(s) can be chosen to have the desired level of pattern/polarization/spatial diversity. Alternatively, the antenna of the present disclosure can be used in combination with one or more other antenna types in a MIMO/SIMO configuration (i.e., a heterogeneous MIMO or SIMO array having multiple different types of antennas).

### Performance

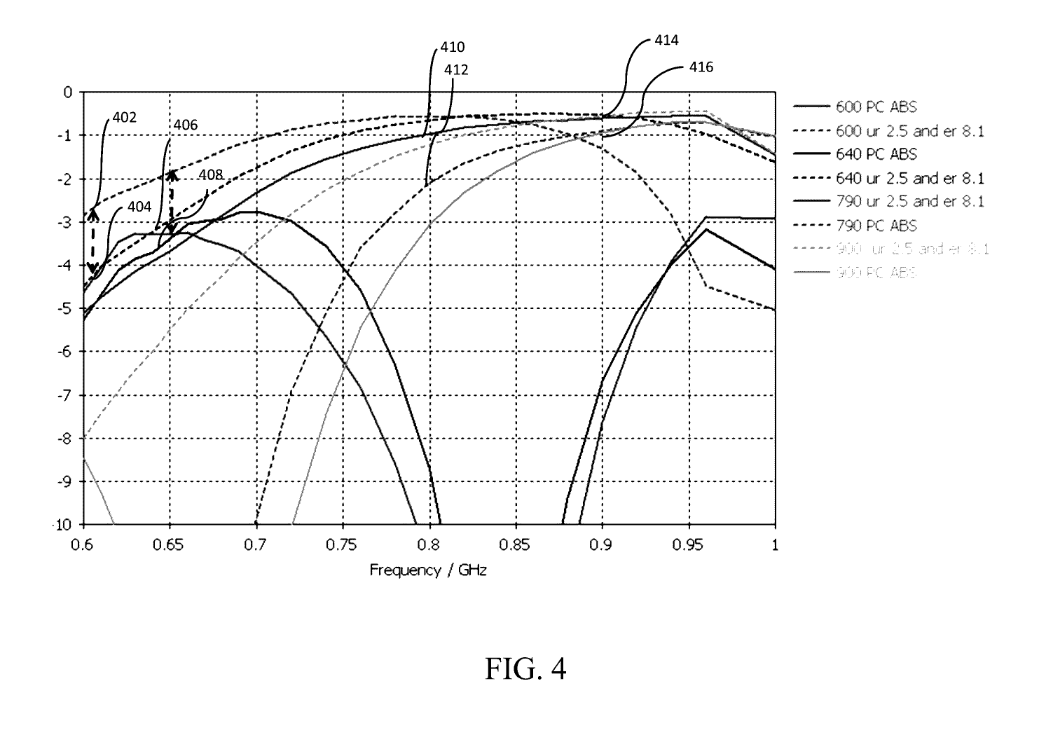

Referring now to FIG. 4, performance results obtained during testing by the Assignee hereof of an exemplary antenna apparatus constructed according disclosure are presented. The exemplary antenna apparatus comprises separate lower band and upper band antenna assemblies, which is suitable for a dual feed front end. Both the lower band assembly and upper band assembly are disposed along a bottom edge of the device (as shown in FIG. 1). However, while a dual feed front end example is illustrated in the performance results of FIG. 4, it is appreciated that a diplexer can also be used after the antenna in order to combine these two feeds into a single feed front end.

The antenna efficiency (in dB) is defined as decimal logarithm of a ratio of radiated and input power:

$$AntennaEfficiency = 10 {log}_{10} ( \frac{Radiated Power}{Input Power} ) \qquad Eqn . ( 1 )$$

An efficiency of zero (0) dB corresponds to an ideal theoretical radiator, wherein all of the input power is radiated in the form of electromagnetic energy.

FIG. 4 illustrates antenna efficiency for both a mobile device manufactured from: (1) a traditional polycarbonate-acrylonitrile butadiene styrene (PC-ABS) blend; as well as (2) a mobile device manufactured with the inventive composite material having a magnetic permeability μᵣ equal to approximately 2.5 and a dielectric permeability Eᵣ equal to approximately 8.1 over a frequency range from 600 MHz to 1 GHz. The data in FIG. 4 demonstrates that the antenna of the disclosure positioned on the portable device achieves a total efficiency (402) of approximately −3.0 for the composite material at a frequency of 600 MHz and a total efficiency (404) of approximately −4.5 for the PC-ABS material at a similar frequency. Moreover, the antenna of the disclosure positioned on the portable device achieves a total efficiency (406) of approximately −3.0 for the composite material at a frequency of 640 MHz and a total efficiency (408) of approximately −3.5 for the PC-ABS material at a similar frequency. The antenna of the disclosure positioned on the portable device achieves a total efficiency (410) of approximately −1.0 for the composite material at a frequency of 790 MHz and a total efficiency (412) of approximately −2.0 for the PC-ABS material at a similar frequency. Finally, the antenna of the disclosure positioned on the portable device achieves a total efficiency (414) of approximately −0.5 for the composite material at a frequency of 900 MHz and a total efficiency (416) of approximately −1.0 for the PC-ABS material at a similar frequency.

As persons skilled in the art appreciate, the frequency band composition given above may be modified as required by the particular application(s) desired, and additional bands may be supported/used as well. While a specific frequency range is illustrated, it is appreciated that the benefits of utilizing the composite material for the loading ring and antenna frame are not necessarily limited to this operational band and similar benefits would be seen at a variety of frequency ranges as previously discussed herein.

Advantageously, an antenna configuration that uses the loaded antenna configuration as in the illustrated embodiments described herein allows for optimization of antenna operation in lower frequency bands independent of the upper band operation. In other words, in low-band (LB) and high-band (HB) applications, if the electrical distance between the LB and HB radiator increases, the isolation also improves, thus leading to more independence of tuning for the individual LB and HB antennas. Furthermore, and as discussed previously herein, the use of a loaded antenna/chassis structure reduces antenna size for the same performance, which in turn allows for smaller portable communication devices.

### Methods of Manufacturing—

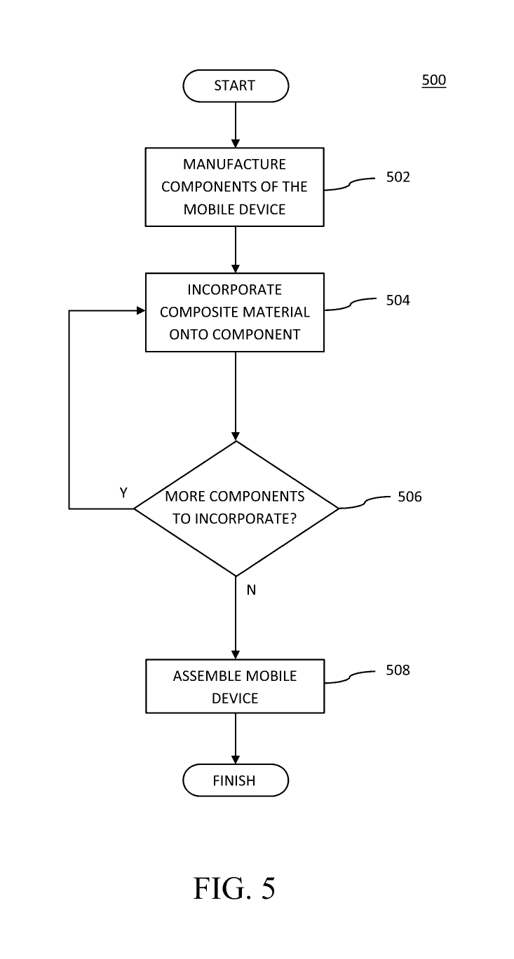

FIG. 5 is a logical flow diagram illustrating one embodiment of a method of manufacturing the mobile device of the present disclosure. As shown in FIG. 5, the first step 502 in the method 500 is to manufacture the components of the mobile device. These components include, inter alia, the mobile device housing, the mobile device chassis, the mobile device antenna frame and the mobile device loading structure (e.g., a ring).

At step 504, a component manufactured at step 502 incorporates the exemplary composite material onto the component. Moreover, in some embodiments, such as variants of the mobile device loading structure, the entire component will be manufactured from the exemplary composite material and both steps 502 and 504 are completed in a single processing step.

At step 506, a decision to determine whether more components manufactured need to incorporate the composite material is made. If so, the process returns to step 504 where the component manufactured at step 502 incorporates the exemplary composite material onto the component. For example, in mobile devices which incorporate the composite material onto the loading structure, the antenna chassis and the antenna frame, step 506 will need to be revisited a total of four (4) times and step 504 will need to be revisited a total of three (3) times. Upon revisiting step 506 the fourth time, no more components are left which need to incorporate the composite material and the process advances to step 508.

At step 508, the components manufactured at step 502 as well as the components that incorporated the composite material at step 504 are assembled into the final mobile device with the exemplary antenna loading structure incorporated therein.

It will be recognized that while certain aspects of the disclosure are described in terms of a specific sequence of steps of a method, these descriptions are only illustrative of the broader methods of the disclosure, and may be modified as required by the particular application. Certain steps may be rendered unnecessary or optional under certain circumstances. Additionally, certain steps or functionality may be added to the disclosed embodiments, or the order of performance of two or more steps permuted. All such variations are considered to be encompassed within the disclosure disclosed and claimed herein.

While the above detailed description has shown, described, and pointed out novel features of the disclosure as applied to various embodiments, it will be understood that various omissions, substitutions, and changes in the form and details of the device or process illustrated may be made by those skilled in the art without departing from the disclosure. The foregoing description is of the best mode presently contemplated of carrying out the disclosure. This description is in no way meant to be limiting, but rather should be taken as illustrative of the general principles of the disclosure. The scope of the disclosure should be determined with reference to the claims.

What is claimed is:

1. An antenna apparatus for use in a portable communications device, the apparatus comprising:
a radiator element;
a ground plane; and
a load structure disposed proximate the radiator element and the ground plane; and
wherein at least a portion of the load structure comprises a composite material, the at least portion configured to enhance the radiation efficiency of the antenna apparatus.

2. The antenna apparatus of claim 1, wherein the load structure is incorporated into one or more of a portable communications device chassis, a portable communications device antenna frame and a portable communications device loading ring.

3. The antenna apparatus of claim 2, wherein the composite material has a magnetic permeability equal to approximately 2.5 and a dielectric permeability equal to approximately 8.1.

4. The antenna apparatus of claim 2, wherein the composite material has a dielectric permittivity to magnetic permeability ratio of approximately 3.2.

5. The antenna apparatus of claim 2, wherein the load structure is incorporated into two or more of a portable communications device chassis, a portable communications device antenna frame and a portable communications device loading ring.

6. The antenna apparatus of claim 2, wherein the composite material is insert-molded into at least a portion of the load structure.

7. The antenna apparatus of claim 1, wherein the load structure comprises a ring like structure configured to be disposed about a periphery of the portable communications device.

8. The antenna apparatus of claim 7, wherein the ring like structure is configured to be disposed on the smallest one of a length dimension, a width dimension and a height dimension for the portable communications device.

9. The antenna apparatus of claim 8, wherein the ring like structure is a substantially planar structure having a thickness on the order of approximately 1 mm.

10. The antenna apparatus of claim 1, wherein the composite material is configured to provide structural support and/or stability for the portable communications device.

11. A portable communications device, comprising:
a housing having at least a top and a bottom surface as well as two side surfaces that are disposed adjacent to both the top and the bottom surfaces;
a chassis disposed within the housing; and
an antenna apparatus disposed on an antenna frame, the antenna apparatus comprising:
a radiator element;
a ground plane; and
a composite material disposed proximate at least the ground plane, the composite material configured to enhance the radiation efficiency of the antenna apparatus.

12. The portable communications device of claim 11, further comprising a ring like structure that is disposed on at least the top and the two side surfaces of the housing.

13. The portable communications device of claim 12, wherein the ring like structure comprises the composite material.

14. The portable communications device of claim 13, wherein the chassis comprises the composite material.

15. The portable communications device of claim 14, wherein the antenna frame comprises the composite material; and
wherein the incorporation of the composite material into the ring like structure, the chassis and the antenna frame is configured to improve the radiation efficiency of the antenna apparatus as compared with a portable communications device in which the composite material is only disposed on a single one of the ring like structure, the chassis and the antenna frame.

16. The portable communications device of claim 11, wherein the composite material has a magnetic permeability equal to approximately 2.5 and a dielectric permeability equal to approximately 8.1.

17. The portable communications device of claim 11, wherein the composite material has a dielectric permittivity to magnetic permeability ratio of approximately 3.2.

18. The portable communications device of claim 11, wherein the composite material is insert-molded into at least a portion of the chassis.

19. A method of enhancing the radiation efficiency of an antenna apparatus, comprising:
providing a radiator element;
providing a ground plane;
disposing a composite material onto a loading structure comprised of a metallic material; and
disposing the load structure proximate the radiator element and the ground plane;
wherein at least a portion of the loading structure is configured to enhance the radiation efficiency of the antenna apparatus.

20. The method of claim 19, wherein the composite material has a dielectric permittivity to magnetic permeability ratio of approximately 3.2.
